(19) United States
(12) Patent Application Publication
(10) Pub. No.: US 2026/0004163 A1
(43) Pub. Date: Jan. 1, 2026

(54) MANAGING INFERENCE MODELS BASED ON LEVELS OF SKILL

(71) Applicant: Dell Products L.P., Round Rock, TX (US)

(72) Inventors: OFIR EZRIELEV, Beer Sheva (IL); PANKAJ PANDE, Carlingford (AU)

(21) Appl. No.: 18/756,064

(22) Filed: Jun. 27, 2024

(51) Int. Cl. G06N 5/04

(52) U.S. Cl. CPC G06N 5/04

(57) ABSTRACT

Methods and systems for managing an inference model are disclosed. A prompt for the inference model may be associated with a user. A user level of skill for the user may be identified based on user information for the user. The user level of skill may be used to identify at least one data source with a data source level of skill that corresponds to the identified user level of skill and that includes information relevant to the prompt. The at least one data source and the prompt may be used to generate an ingest data package. The ingest data package may be used as ingest for the inference model so that the inference model generates a response to the prompt using information from the at least one data source as context for the response.

### FIELD

Embodiments disclosed herein relate generally to inference models (e.g., artificial intelligence models). More particularly, embodiments disclosed herein relate to systems and methods to manage inference models based on levels of skill.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. The inference models may be used to provide computer-implemented services (e.g., inference generation) for downstream consumers and/or may facilitate computer-implemented services provided by the downstream consumers. For example, the inference models may include generative inference models (e.g., large language models (LLMs)), which may be used to generate inferences when provided with ingest data (e.g., a prompt).

A quality of the computer-implemented services may depend on a quality of the output (e.g., inferences) generated by the inference models. The quality of the output may depend on factors of the training data used to train the generative model, such as the source, type, and/or quantity of the training data. For example, an inference model trained using unreliable and/or outdated training data may generate inferences that are unreliable and/or outdated. Consequently, the quality of the computer-implemented services may be negatively impacted (e.g., decisions may be made based on the outdated information).

To increase the quality of the output generated by the inference models, prompts for the inference models may be augmented to obtain ingest data packages that may be used as ingest for the inference models. Augmenting the prompt may include identifying at least one data source that is relevant to the prompt and that is desired to be used by the inference model as context during inference generation (e.g., due to being up-to-date and reliable). The prompt and the at least one data source may be compiled to obtain the ingest data package.

Obtaining the ingest data package may include performing a retrieval-augmented generation (RAG) pipeline process. By utilizing the ingest data package (e.g., a RAG output) as ingest during inference generation, a likelihood that the inference model may generate inferences that are relevant, up-to-date, and/or otherwise meet desired criteria may be increased.

Data sources to be included in ingest data packages may be selected based on any criteria. For example, different users may have different user levels of skill (e.g., based on their educational backgrounds, their job responsibilities, their professional experience level). If an ingest data package includes data sources that do not correspond to the user level of skill for a user (e.g., data sources that include a level of detail that exceeds needs of the user), the user's experience interpreting and/or utilizing inferences based on the ingest data package may be negatively impacted.

To increase a likelihood of providing inferences to users that are relevant based on their user level of skill, data sources included in the ingest data packages may be selected based on data source levels of skill that correspond to the user level of skill for the user.

The data source levels of skill may be assigned to data sources based on, for example, levels of detail of information content of the data sources, levels of complexity of presentation of information content of the data sources, and/or other criteria. Each data source level of skill may correspond to a user level of skill.

Therefore, at least one data source with a data source level of skill that corresponds to the identified user level of skill for the user associated with the prompt may be identified and the at least one data source may be used (along with the prompt) to generate the ingest data package. The ingest data package may be used to initiate inference generation by the inference model.

By doing so, inferences generated by the inference model may have an increased likelihood of providing inferences that are relevant to a downstream consumer (e.g., a user) of the inferences. Therefore, a quality of the computer-implemented services based on the information may be increased.

In an embodiment, a method for managing an inference model is provided. The method may include: obtaining a prompt for the inference model, the prompt being associated with a user; identifying a user level of skill for the user to obtain an identified user level of skill; discriminating, using the identified user level of skill for the user and the prompt, at least one data source from a set of data sources, each data source of the set of the data sources being keyed to different data source levels of skill, and the at least one data source being keyed to a data source level of skill that corresponds to the identified user level of skill and comprising information relevant to the prompt; obtaining, using the prompt and the at least one data source, an ingest data package for the inference model; and initiating generation of an inference by the inference model using the ingest data package, the inference comprising a response to the prompt using information obtained from the at least one data source as context for the response, and the inference being usable to provide computer-implemented services.

Identifying the user level of skill may include: obtaining user information for the user; and comparing, using a schema for assigning user levels of skill to users, the user information to a ranked list of user levels of skill corresponding to portions of user information.

The user information may include at least one type of data selected from a list of types of data consisting of: self-reported user input indicating the user level of skill of the user; historical behavior of the user; an educational background of the user; and a job title for the user.

Each data source of the set of data sources may include information content that is relevant to the prompt, each data source having different information content, and the information content of each data source being rated using a schema that defines the level of skill keyed to the respective data source.

The schema may quantify, for any data source, a level of detail of information content of the any data source.

The schema may quantify, for any data source, a level of complexity of presentation of information content of the any data source.

The level of complexity of presentation may be based on at least one selected from a group consisting of: specificity of terminology used to present the information content; type of graphical representations used to present the information content; and level of self-descriptiveness of the any data source.

The ingest data package may be a retrieval-augmented generation (RAG) output from a RAG pipeline process, the RAG pipeline process including, at least, the identifying of the user level of skill, the discriminating of the at least one data source, and the obtaining the ingest data package.

The inference model may be a large language model (LLM).

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

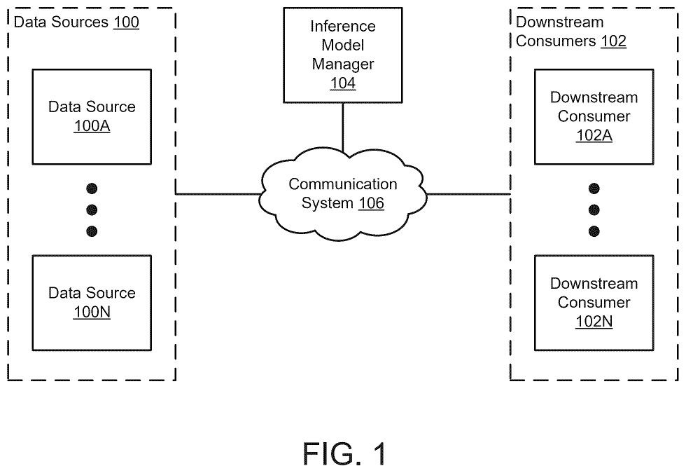

Turning to FIG. 1, a block diagram illustrating a system in accordance with an embodiment is shown. The system shown in FIG. 1 may provide, at least in part, computer-implemented services. The computer-implemented services may include any type and quantity of services including, for example, data services (e.g., data storage, access and/or control services), communication services (e.g., instant messaging services, video-conferencing services), and/or any other type of service that may be implemented with a computing device. The computer-implemented services may be provided by, for example, data sources 100, inference model manager 104, downstream consumers 102, and/or any other type of devices (not shown in FIG. 1). Other types of computer-implemented services may be provided by the system shown in FIG. 1 without departing from embodiments disclosed herein. The computer-implemented services may be provided, at least in part, using inference models and/or inferences obtained using the inference models.

To provide the computer-implemented services, the inference models may be trained, using training data, to generate inferences when provided with a prompt (e.g., ingest data). The inference models may include generative inference models (e.g., large language models (LLMs)). Therefore, the inferences may include new instances of data created by the generative inference models based on learned associations from and/or an understanding of the training data. For example, the inference models may be trained using unstructured data, such as stories, essays, audio transcription, video description, and/or other types of human interpretable text, to generate inferences of the same. The inferences may be provided to downstream consumers as a computer-implemented service and/or in order to facilitate computer-implemented services provided by the downstream consumers.

For example, users of downstream consumers 102 may be employees of a company and the employees may make business decisions based on information included in inferences generated by an inference model.

However, a quality of the output (e.g., inferences) generated by the inference models may be impacted by a quality of the training data used to train the inference models. For example, if an inference model is trained using training data that is: (i) unreliable, (ii) out-of-date, (iii) fabricated, and/or (iv) otherwise of a quality that does not meet expectations of the user, inferences generated by the inference model may not meet expectations of the user.

To increase a likelihood that inferences meet expectations of a user, ingest data packages may be obtained for the inference models. Ingest data packages may include the prompt and at least one data source to be used as context during inference generation by an inference model. The at least one data source may be selected due to an information content of the data source being considered reliable, up-to-date, and/or otherwise meeting criteria for the user. Obtaining the ingest data package may be performed, for example, via a RAG pipeline process. By doing so, the inference model may utilize data from the selected at least one data source as context while generating a response to the prompt. Consequently, a quality of the response may be more likely to meet expectations of a user and a quality of computer-implemented services based on the response may be increased.

However, criteria for selection of data sources to be included in ingest data packages may impact the user's experience interpreting and/or providing computer-implemented services based on the inferences. For example, different users with different user levels of skill may provide prompts to a generative inference model. A level of skill for a user may determine characteristics of data sources that are considered relevant (e.g., useful, comprehendible) to the user and may be based on user information for the user.

A user level of skill for a user may be self-reported (e.g., a user may select their user level of skill) and/or may be inferred based on information such as historic behavior of a user, an educational background of a user, a job title of a user, etc. Therefore, a degree of relevance of inferences generated by the inference model may be reduced if the inference presents information that does not correspond to the user level of skill for the user.

For example, information included in the inference and/or the data sources used as context to generate the inference may display a level of detail that does not meet expectations of the user, a level of complexity of presentation of information that does not meet expectations of the user, and/or otherwise may not align with the user level of skill for the user.

For example, a first employee (e.g., a first user of downstream consumer 102A) may hold a position in a sales department for a company and may provide a prompt to an LLM requesting information related to forecasted sales for the company over the following year. A second employee (e.g., a second user of downstream consumer 102B) may hold a position in an accounting department for the same company. The second employee may provide the same prompt to the LLM requesting information related to forecasted sales for the company over the following year.

The second employee may desire access to information with a higher level of detail and/or information presented with a higher degree of complexity than the first employee based on a desired use of the information. Specifically, the second employee may intend to use the inference to perform data analysis related to financial performance of the company and the first employee may wish to compile higher-level data for use in generating marketing materials for the company. The second employee may, therefore, have a higher user level of skill than the first employee.

An ingest data package may identify data sources that include large quantities of raw data (e.g., payroll data for the company) and may use the raw data as context for responding to the prompt. The response generated by the inference model may include information that is not relevant to the second user (e.g., the second user may not desire less granular information). Therefore, if inferences generated by an inference model do not correspond to a level of skill for the user, the user's experience and/or a quality of computer-implemented services based on the inferences may be negatively impacted.

In general, embodiments disclosed herein may provide methods, systems, and/or devices for managing inference models in a manner that increases a likelihood of providing desired computer-implemented services. To do so, a user level of skill may be identified for a user associated with a prompt for an inference model. In addition, data sources relevant to the prompt may be assigned data source levels of skill based on a type, quantity, and/or presentation of informational content of the data sources. Data sources may be selected so that data source levels of skill of the data sources correspond to the identified user level of skill for the user. The selected data sources and the prompt may be provided to the inference model as an ingest data package and the inference model may generate inferences that are responsive to the prompt and that utilize information obtained from the selected data sources as context for the response.

By doing so, a likelihood that inferences generated by an inference model are relevant to a downstream consumer of the inferences may be increased. Consequently, a quality of the user's experience and/or the computer-implemented services provided based on the inferences by the downstream consumer may be increased.

To provide the above noted functionality, the system of FIG. 1 may include data sources 100, downstream consumers 102, inference model manager 104, and communication system 106. Each of these components is discussed below.

Data sources 100 may include any type and/or number of data sources (e.g., 100A, 100N). Each data source of data sources 100 may include hardware and/or software components configured to obtain data, store data, provide data to other entities, and/or to perform any other task to facilitate performance of the computer-implemented services. All, or a portion, of data sources 100 may provide (and/or participate in and/or support the) computer-implemented services to various devices operably connected to data sources 100. Different data sources may provide similar and/or different computer-implemented services.

For example, data sources 100 may be used to obtain (i) training data usable to train inference models (e.g., generative inference models), (ii) ingest data usable to prompt inference models to generate an inference, and/or (iii) other data (e.g., context specified by RAG outputs for ingestion by generative inference models). Data sources 100 may include data repositories (e.g., training data repositories), and may provide data to (e.g., allow access to data by) inference model manager 104.

Data sources 100 may be organized so that each data source of data sources 100 is keyed to a data source level of skill. Data source levels of skill may be based on information content of data sources 100 and each data source level of skill may be associated with a user level of skill. For example, multiple data source levels of skill may be associated with each user level of skill.

Data source levels of skill may be based on characteristics of the information content of data sources 100 as defined by a schema for assigning data source levels of skill. The schema for assigning data source levels of skill may indicate that a level of detail of the information content of any data source and/or a level of complexity of presentation of information content of any data source may contribute to the data source level of skill for the data source.

Inference model manager 104 may perform tasks relating to management of and/or facilitation of use of inference models. For example, inference model manager 104 may: (i) manage (e.g., facilitate) training processes for the inference models, (ii) obtain (e.g., generate, retrieve) ingest data packages, (iii) manage inferencing processes using the inference models (and the ingest data packages), and/or (iv) distribute inferences obtained using the inference models to downstream consumers 102.

Ingest data packages may be used as ingest for inference models (e.g., generative inference models). To obtain the ingest data packages, inference model manager 104 (and/or any other entity) may: (i) obtain a prompt for the inference model, the prompt being associated with a user (e.g., a user of downstream consumer 102A), (ii) identify a user level of skill for the user to obtain an identified user level of skill, (iii) discriminate, using the identified user level of skill for the user and the prompt, at least one data source from a set of data sources (e.g., of data sources 100), and/or (iv) obtain, using the prompt and the at least one data source, an ingest data package for the inference model.

Obtaining the ingest data packages may include, for example, performing RAG pipeline processes.

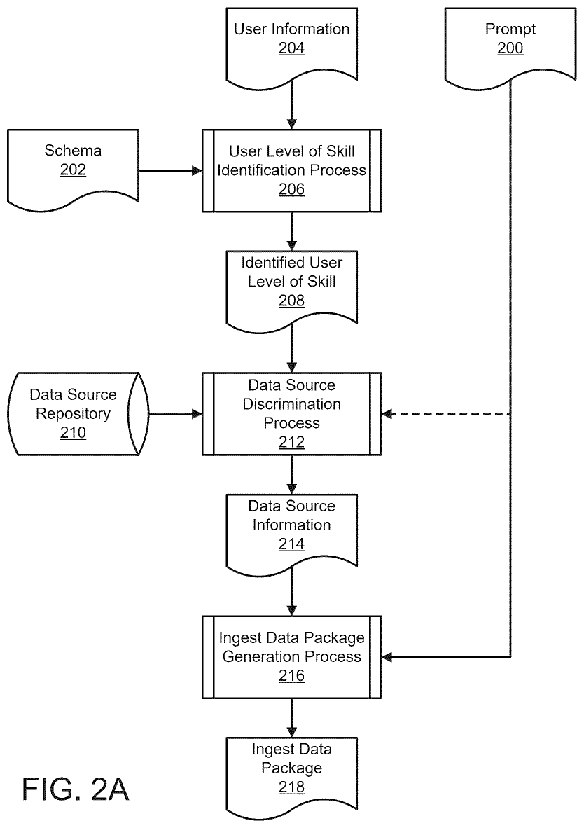

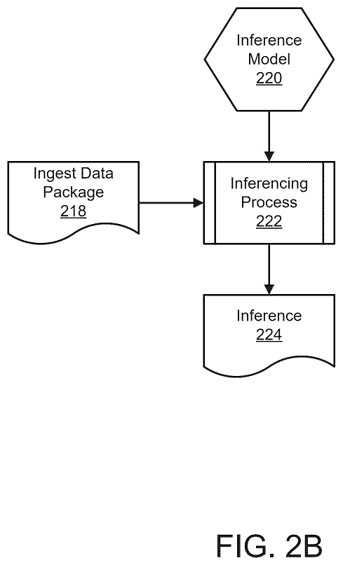

Each data source of the set of the data sources (e.g., a sub-set of data sources 100) may be previously selected as including information relevant to the prompt and may be keyed to a data source level of skill. The at least one data source (e.g., data source 100A) may be keyed to a data source level of skill that corresponds to the identified user level of skill. Refer to FIG. 2A for additional details regarding levels of skill (e.g., user levels of skill, data source levels of skill).

Inference model manager 104 may utilize the ingest data package to initiate generation of an inference by the inference model (e.g., by feeding the ingest data package into an inference model, by providing the ingest data package to downstream consumer 102A to perform inference generation). The inference may include a response to the prompt using information obtained from the at least one data source as context for the response.

Downstream consumers 102 may provide and/or consume all, or a portion of, the computer-implemented services. Downstream consumers 102 may include any number of downstream consumers (e.g., 102A, 102N) and may include, for example, businesses, individuals, and/or computers that may use inferences to improve decision-making and/or automate tasks. Downstream consumers 102 may subscribe to services using, in part, inference models managed by inference model manager 104.

For example, downstream consumers 102 may: (i) obtain prompts associated with users, (ii) obtain user information for users associated with the prompts, (iii) provide the prompts and/or the user information to another entity responsible for generating ingest data packages (e.g., inference model manager 104), (iv) obtain ingest data packages, (v) obtain inferences based on the ingest data packages, (vi) provide computer-implemented services (e.g., make decisions) based on the inferences, and/or (vii) perform other tasks.

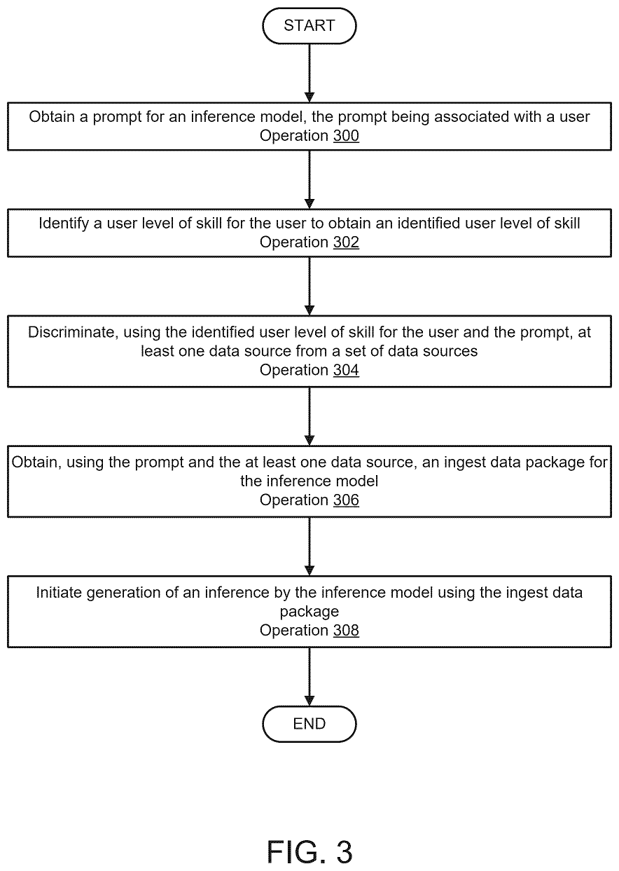

When providing their functionality, any of (and/or components thereof) data sources 100, downstream consumers 102, and/or inference model manager 104 may perform all, or a portion, of the actions and methods illustrated in FIGS. 2A-3.

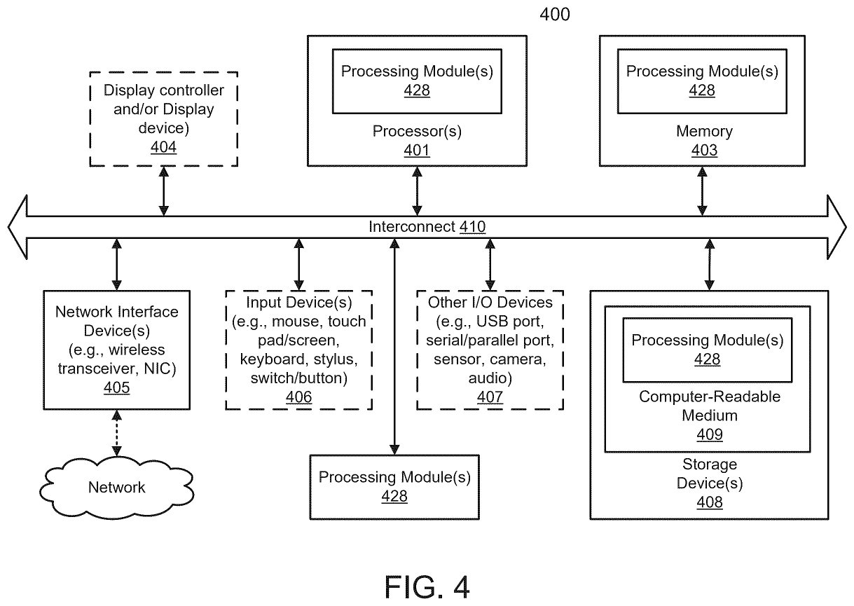

Any of (and/or components thereof) data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 202, etc.) is used to represent data structures, a second set of shapes (e.g., 206, 212, etc.) is used to represent processes performed using and/or that generate data, a third set of shapes (e.g., 210, etc.) is used to represent large scale data structures such as databases, and a fourth set of shapes (e.g., 220) is used to represent trained inference models and/or portions of trained inference models.

Turning to FIG. 2A, a first data flow diagram in accordance with an embodiment is shown. The first data flow diagram may illustrate data used in and data processing performed when facilitating obtaining ingest data packages for an inference model. In the example shown in FIG. 2A, obtaining the ingest data package may include performing a RAG pipeline process.

To obtain the ingest data package (e.g., ingest data package 218), prompt 200 and user information 204 may be obtained.

Prompt 200 may include text in human-readable language which may be used as input for an inference model. Prompt 200 may include information to be used as a guide and/or instructions by an inference model (e.g., an LLM) to generate an inference. The inference may include (i) text, (ii) an image, (iii) a video, (iv) audio, and/or (v) other types of output that may be generated by a generative inference model. For example, an LLM may be used to generate a summary of forecasted sales for a company based on prompt 200. In this example, prompt 200 may include the text “summarize quarterly sales projections for 2025” which may be used by the LLM to generate an output (e.g., an inference).

Prompt 200 may be associated with a user (e.g., may be generated by the user, may be intended for use by the user). For example, a first user may be a first employee of a company that works in a sales department and a second user may be a second employee of the company that works in an accounting department for the company.

User information 204 may include data associated with the user that may be used to discern a user level of skill for the user. User information 204 may include: (i) self-reported user input indicating the level of skill of the user, (ii) historical behavior of the user, (iii) an educational background of the user, (iv) a job title for the user, and/or (v) other information associated with the user.

The self-reported user input may include a result of the user's interaction with a graphical user interface (GUI). The GUI may present the user with a ranked list of levels of skill (e.g., with associated descriptions to guide the user's decision) and/or may present the user with any number of questions (e.g., a questionnaire) to self-identify the level of skill for the user. The questionnaire may include questions regarding the user's job responsibilities, the user's educational background, the user's years of work experience in a particular field, etc.

The historical behavior of the user may include: (i) documents a user has accessed and/or interacted with (e.g., full documents, segments of documents), (ii) websites visited by the user, (iii) work experience of the user, (iv) publications written by the user, (v) presentations given by the user, and/or (vi) other historical behavior that may be used to identify relevant information for the user.

The educational background of the user may include: (i) educational institutions attended by the user, (ii) types of degrees earned by the user at the educational institutions, (iii) fields of study of the user at the educational institutions, (iv) professional development completed by the user, and/or (v) other records of educational experiences for the user that may be used to identify relevant information for the user.

The job title for the user may be used to identify: (i) a set of job responsibilities for the user, (ii) promotions received by the user, (iii) a level of detail of information typically encountered by the user, (iv) a level of complexity of presentation of information typically encountered by the user, and/or (v) other information.

For example, a first user may work in a sales department for a company and may be responsible for selling a product built by the company to customers. User information for the first user may indicate that the first user has an educational background in marketing and ten years of experience. Additional user information for the first user may include a record of publications generated by the first user, which may include summaries of forecasted quarterly sales for the company displayed as bar graphs and/or line graphs.

A second user may work in an accounting department for the company and may be responsible for generating financial projection reports for the company. To do so, the second user may aggregate large quantities of data for the company (e.g., payroll data, sales data, business operating cost data) and may analyze the data to generate the financial projection reports for the company. User information for the second user may indicate that the second user is a certified public accountant (CPA) with a degree in accounting and five years of professional experience. The user information may also include records of documents historically accessed by the second user (e.g., raw payroll data, raw sales data, business operating cost data) as well as historic documents generated by the second user (e.g., graphical illustrations of the company's cash flow, spreadsheets of raw and/or derived data values).

User information 204 and schema 202 may be used to perform user level of skill identification process 206. Schema 202 may include instructions, a rule set, and/or other information related to methods of assigning user levels of skill based on user information. During user level of skill identification process 206, user information 204 may be compared to a ranked list of user levels of skill corresponding to portions of user information. Different levels of skill of the ranked list of the levels of skill may be associated with portions of user information that indicate characteristics of information content likely to be relevant to the user. For example, a first user level of skill may be associated with a portion of user information indicating frequent access to raw data and a second user level of skill may be associated with a portion of user information indicating frequent access to summaries of data.

Identified user level of skill 208 may be identified based on a degree to which user information 204 aligns with each user level of skill of the ranked list of the user levels of skill (e.g., identified user level of skill 208 may be associated with a portion of user information that most closely corresponds to user information 204).

Identified user level of skill 208 may include multiple user levels of skill to indicate, for example, levels of skill for the in different fields (e.g., content areas). For example, identified user level of skill 208 may include a first identified user level of skill for a first field (e.g., finance) and a second identified user level of skill for a second field (e.g., chemistry).

Identified user level of skill 208 may include an identifier associated with a user level of skill of the ranked list of the user levels of skill. For example, identified user level of skill 208 may include a numerical indicator (e.g., a number between 1 and 10), a label in human-interpretable text indicating a relative rank of identified user level of skill 208 (e.g., “high”, “first”), may include instructions to access the associated portion of user information from the ranked list of the user levels of skill, and/or may be presented in other ways.

To identify at least one data source to be added to the ingest data package based on identified user level of skill 208, data source discrimination process 212 may be performed. During data source discrimination process 212, prompt 200 may be used to identify a set of data sources (e.g., a portion of data sources) included in data source repository 210 that include information relevant to prompt 200. The set of the data sources may be previously identified and/or may be identified as part of data source discrimination process 212. Identified user level of skill 208 may be used to identify at least one data source of the set of the data sources that has a data source level of skill corresponding to identified user level of skill 208.

Data source repository 210 may include information related to any number of data sources that may be stored locally and/or remote to data source repository 210. The information may include titles of the data sources, storage locations for the data sources, instructions for accessing the information stored in the data sources, and/or other information regarding the data sources. Data source repository 210 may also include characteristics of each data source. The characteristics may include: (i) key words associated with information content of each data source, (ii) a data source level of skill keyed to each data source, and/or (iii) other information.

To identify the set of the data sources, portions of information included in the prompt (e.g., keywords) may be used to search data source repository 210 to identify data sources with characteristics that indicate the data source may include information relevant to the prompt. The set of the data sources (not shown) may also be obtained by manual selection of the set of the data sources by a subject matter expert (SME).

Each data source of the set of the data sources may: (i) include information that is relevant to the prompt, (ii) have different information content, and/or (iii) be keyed to a data source level of skill.

The information content of the data source may be based on a type and/or quantity of information included in the data source. For example, a first data source may have informational content including raw payroll data presented in the form of a spreadsheet including quantities for every paycheck issued to every employee of the company over the past year. A second data source may have informational content including aggregated annual payroll data organized by department for the company.

Two data sources may be determined to have different information content if at least a portion of the information content included in each of the two data sources does not overlap.

The information content of each data source of the set of the data sources may be rated using a schema (not shown) that defines a data source level of skill keyed to the respective data source. For example, the schema may quantify, for any data source, a level of detail of information content of the any data source. The schema may also quantify, for any data source, a level of complexity of presentation of information content of the any data source and/or other means of evaluating the information content of the any data source.

The level of detail of information content may be based on an amount of data available from the data source, a level of granularity of the data available from the data source (e.g., raw data values, aggregated data values, derived data values, data values rounded to a particular order of magnitude), and/or metrics related to the level of detail of the data source. Raw data values, for example, may be assigned a higher level of detail than aggregated data values.

The level of complexity of presentation of the information content may be based on at least one of: (i) specificity of terminology used to present the information content, (ii) type of graphical representations used to present the information content, (iii) level of self-descriptiveness of any data source.

The specificity of terminology used to present the information may be based on an intended audience for the information content. For example, specialized technical terminology may be meaningful to a specialist in a field, while a beginner in the field may be unfamiliar with the specialized technical terminology. In contrast, more generalized (e.g., colloquial) terminology may be comprehendible by a wider audience with a range of educational and/or professional backgrounds.

The type of graphical representations used to present the information may influence the data source level of skill. For example, a first type of graphical representation may include a bar graph displaying annual revenue for a company over the past five years. A second type of graphical representation may include results of a chemical analysis of a product sold by the company displayed as an infrared spectrum. The infrared spectrum may be interpretable by a narrower audience (e.g., those with a background in analytical chemistry) than the bar graph.

The level of self-descriptiveness of any data source may be based on a degree of summarization and/or discussion included with data presented by the data source. For example, a large dataset of raw data may include temperature measurements collected by a temperature sensor every minute for a week. However, there may be no human-interpretable text along with the raw data to assign any meaning to the raw data. However, a second dataset of raw data may include a one-page summary of the findings from the temperature measurements using colloquial terminology. Therefore, the second dataset may have a higher likelihood of being interpretable by a wider audience than the first dataset.

Data source levels of skill may be assigned based on any number of the above criteria using any rule set for assigning data source levels of skill. For example, characteristics of information content of a data source may be extracted and compared to a ranked list of data source levels of skill with corresponding descriptions. The descriptions may indicate portions of characteristics of information content for data sources associated with each data source level of skill.

Data source levels of skill may be previously assigned to each data source of data source repository and/or may be assigned as part of data source discrimination process 212.

Any number of data sources (e.g., at least one data source) may be identified during data source discrimination process 212 to obtain data source information 214. Data source information 214 may include an identifier for each identified data source that has a data source level of skill associated with identified user level of skill 208 and that includes information relevant to prompt 200. Data source information 214 may include data sources, instructions for how to access the data sources, titles for the data sources, locations of the data sources, data source levels of skill keyed to the data sources, and/or other information related to the identified data sources.

To generate the ingest data package, ingest data package generation process 216 may be performed. During ingest data package generation process 216, prompt 200 and data source information 214 may be compiled to obtain ingest data package 218. Ingest data package 218 may indicate that data sources identified in data source information 214 are to be used as context while generating a response to the prompt by an inference model. Therefore, an inference model may extract information from the data sources indicated by ingest data package 218 and may base the response to the prompt, at least in part, on the extracted information.

Ingest data package 218 may be a RAG output from a RAG pipeline process. The RAG pipeline process may include at least: (i) user level of skill identification process 206, (ii) data source discrimination process 212, and (iii) ingest data package generation process 216.

Ingest data package 218 may usable as ingest for an inference model. The inference model may be a generative inference model (e.g., an LLM) and may include a neural network.

Therefore, inferences generated using ingest data package 218 may have a higher likelihood of being relevant to the user associated with prompt 200 than inferences generated using only prompt 200. Consequently, the user experience may be improved, and computer-implemented services provided based on the inferences may be improved.

Turning to FIG. 2B, a second data flow diagram in accordance with an embodiment is shown. The second data flow diagram may illustrate data used in and data processing performed during inference generation by an inference model.

To generate inferences, inferencing process 222 may be performed. During inferencing process 222, ingest data package 218 may be fed into inference model 220 to obtain inference 224 as output from inference model 220. During inferencing process 222, inference model 220 (e.g., an LLM) may retrieve information from data sources indicated by ingest data package 218 while generating inference 224.

Inference 224 may be provided to downstream consumers (e.g., 102) as a computer-implemented service and/or to facilitate further computer-implemented services. Computer-implemented services performed using and/or based on inference 224 may have an increased likelihood of being relevant, accurate, and/or reliable due to the retrieval of the selected data sources indicated by ingest data package 218.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components and/or data structures of FIG. 1 may perform various methods to provide inference model management services in a manner that increases a likelihood that inferences generated by inference models are relevant to downstream consumers (e.g., users) of the inferences. FIG. 3 illustrates methods that may be performed by the components of FIG. 1. In the diagram discussed below and shown in this figure, any of the operations may be repeated, performed in different orders, omitted, and/or performed in parallel and/or a partially overlapping in time manner with other operations.

Turning to FIG. 3, a flow diagram illustrating a method of managing an inference model in accordance with an embodiment is shown. The method may be performed, for example, by a data processing system, a downstream consumer, an inference model manager, and/or other entities.

At operation 300, a prompt may be obtained for an inference model, the prompt being associated with a user. Obtaining the prompt may include: (i) reading the prompt from storage, (ii) receiving the prompt from another entity, (iii) generating the prompt, and/or (iv) other methods.

At operation 302, a user level of skill may be identified for the user to obtain an identified user level of skill. Identifying the user level of skill may include: (i) obtaining user information for the user, (ii) comparing, using a schema for assigning user levels of skill to users, the user information to a ranked list of user levels of skill corresponding to portions of user information, and/or (iii) other methods.

Obtaining user information for the user may include: (i) prompting the user to provide the user information (e.g., via an interaction with a GUI), (ii) obtaining historic behavior for the user and extracting the user information from the historic behavior (e.g., by reading the historic behavior from storage, by receiving the historic behavior from another entity), (iii) reading the user information from storage, (iv) compiling the user information from publicly available (and/or internally available) data sources, and/or (v) other methods.

Comparing the user information to the ranked list of the user levels of skill may include obtaining instructions included in the schema and, based on the instructions: (i) performing a lookup process using a user level of skill lookup table and at least a portion of the user information as a key for the user level of skill lookup table, (ii) obtaining a data structure displaying the ranked list of the user levels of skill and portions of user information corresponding to each ranked user level of skill, (iii) matching the user information to the portions of the user information to identify a user level of skill from the ranked list that most closely aligns with the obtained user information, and/or (iv) other methods.

Identifying the user level of skill may also include: (i) reading the user level of skill from storage, (ii) receiving the user level of skill from another entity, and/or (iii) other methods.

At operation 304, at least one data source may be discriminated from a set of data sources using the identified user level of skill for the user and the prompt. Discriminating the at least one data source may include: (i) obtaining the set of the data sources, (ii) identifying a data source level of skill associated with each data source of the set of the data sources, (iii) identifying data sources of the set of the data sources that have data source user levels of skill that correspond to the user level of skill (e.g., using a rubric for alignment of data source levels of skill with user levels of skill), and/or (iv) other methods.

At operation 306, an ingest data package for the inference model may be obtained using the prompt and the at least one data source. Obtaining the ingest data package may include: (i) reading the ingest data package from storage, (ii) receiving the ingest data package from another entity, (iii) generating the ingest data package, and/or (iv) other methods.

Generating the ingest data package may include: (i) compiling the prompt and an identifier for the at least one data source into a data structure, (ii) providing the prompt and the identifier for the at least one data structure to another entity responsible for generating ingest data packages, and/or (iii) other methods.

The methods described in at least operations 302, 304, and 306 may be part of a RAG pipeline process.

At operation 308, generation of an inference by the inference model may be initiated using the ingest data package. Initiating generation of the inference by the inference model may include: (i) providing the ingest data package to an entity responsible for hosting and operating the inference model, (ii) feeding the ingest data package into the inference model and obtaining the inference as output from the inference model, and/or (iii) other methods.

The method may end following operation 308.

Thus, using the method shown in FIG. 3, embodiments disclosed herein may manage operation of an inference model so that inferences generated by the inference model have a higher likelihood of being relevant to downstream consumers of the inferences (e.g., based on a user level of skill associated with the downstream consumer).

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing an inference model, the method comprising:
obtaining a prompt for the inference model, the prompt being associated with a user;
identifying a user level of skill for the user to obtain an identified user level of skill;
discriminating, using the identified user level of skill for the user and the prompt, at least one data source from a set of data sources, each data source of the set of the data sources being keyed to different data source levels of skill, and the at least one data source being keyed to a data source level of skill that corresponds to the identified user level of skill and comprising information relevant to the prompt;
obtaining, using the prompt and the at least one data source, an ingest data package for the inference model; and
initiating generation of an inference by the inference model using the ingest data package, the inference comprising a response to the prompt using information obtained from the at least one data source as context for the response, and the inference being usable to provide computer-implemented services.

2. The method of claim 1, wherein identifying the user level of skill comprises:
obtaining user information for the user; and
comparing, using a schema for assigning user levels of skill to users, the user information to a ranked list of user levels of skill corresponding to portions of user information.

3. The method of claim 2, wherein the user information comprises at least one type of data selected from a list of types of data consisting of:
self-reported user input indicating the user level of skill of the user;
historical behavior of the user;
an educational background of the user; and
a job title for the user.

4. The method of claim 1, wherein each data source of the set of data sources comprises information that is relevant to the prompt, each data source having different information content, and the information content of each data source being rated using a schema that defines the data source level of skill keyed to the respective data source.

5. The method of claim 4, wherein the schema quantifies, for any data source, a level of detail of information content of the any data source.

6. The method of claim 4, wherein the schema quantifies, for any data source, a level of complexity of presentation of information content of the any data source.

7. The method of claim 6, wherein the level of complexity of presentation is based on at least one selected from a group consisting of:
specificity of terminology used to present the information content;
type of graphical representations used to present the information content; and
level of self-descriptiveness of the any data source.

8. The method of claim 1, wherein the ingest data package is a retrieval-augmented generation (RAG) output from a RAG pipeline process, the RAG pipeline process comprising, at least, the identifying of the user level of skill, the discriminating of the at least one data source, and the obtaining the ingest data package.

9. The method of claim 8, wherein the inference model is a large language model (LLM).

10. A non-transitory machine-readable medium having instructions stored therein, which when executed by a processor, cause the processor to perform operations for managing an inference model, the operations comprising:
obtaining a prompt for the inference model, the prompt being associated with a user;
identifying a user level of skill for the user to obtain an identified user level of skill;
discriminating, using the identified user level of skill for the user and the prompt, at least one data source from a set of data sources, each data source of the set of the data sources being keyed to different data source levels of skill, and the at least one data source being keyed to a data source level of skill that corresponds to the identified user level of skill and comprising information relevant to the prompt;
obtaining, using the prompt and the at least one data source, an ingest data package for the inference model; and
initiating generation of an inference by the inference model using the ingest data package, the inference comprising a response to the prompt using information obtained from the at least one data source as context for the response, and the inference being usable to provide computer-implemented services.

11. The non-transitory machine-readable medium of claim 10, wherein identifying the user level of skill comprises:
obtaining user information for the user; and
comparing, using a schema for assigning user levels of skill to users, the user information to a ranked list of user levels of skill corresponding to portions of user information.

12. The non-transitory machine-readable medium of claim 11, wherein the user information comprises at least one type of data selected from a list of types of data consisting of:
self-reported user input indicating the user level of skill of the user;
historical behavior of the user;
an educational background of the user; and
a job title for the user.

13. The non-transitory machine-readable medium of claim 10, wherein each data source of the set of data sources comprises information that is relevant to the prompt, each data source having different information content, and the information content of each data source being rated using a schema that defines the data source level of skill keyed to the respective data source.

14. The non-transitory machine-readable medium of claim 13, wherein the schema quantifies, for any data source, a level of detail of information content of the any data source.

15. The non-transitory machine-readable medium of claim 13, wherein the schema quantifies, for any data source, a level of complexity of presentation of information content of the any data source.

16. A data processing system, comprising:
a processor; and
a memory coupled to the processor to store instructions, which when executed by the processor, cause the processor to perform operations for managing an inference model, the operations comprising:
obtaining a prompt for the inference model, the prompt being associated with a user;
identifying a user level of skill for the user to obtain an identified user level of skill;
discriminating, using the identified user level of skill for the user and the prompt, at least one data source from a set of data sources, each data source of the set of the data sources being keyed to different data source levels of skill, and the at least one data source being keyed to a data source level of skill that corresponds to the identified user level of skill and comprising information relevant to the prompt;
obtaining, using the prompt and the at least one data source, an ingest data package for the inference model; and
initiating generation of an inference by the inference model using the ingest data package, the inference comprising a response to the prompt using information obtained from the at least one data source as context for the response, and the inference being usable to provide computer-implemented services.

17. The data processing system of claim 16, wherein identifying the user level of skill comprises:
obtaining user information for the user; and
comparing, using a schema for assigning user levels of skill to users, the user information to a ranked list of user levels of skill corresponding to portions of user information.

18. The data processing system of claim 17, wherein the user information comprises at least one type of data selected from a list of types of data consisting of:
self-reported user input indicating the user level of skill of the user;
historical behavior of the user;
an educational background of the user; and
a job title for the user.

19. The data processing system of claim 16, wherein each data source of the set of data sources comprises information that is relevant to the prompt, each data source having different information content, and the information content of each data source being rated using a schema that defines the data source level of skill keyed to the respective data source.

20. The data processing system of claim 19, wherein the schema quantifies, for any data source, a level of detail of information content of the any data source.
